(19) United States
(12) Patent Application Publication
(10) Pub. No.: US 2013/0027550 A1
(43) Pub. Date: Jan. 31, 2013

(54) METHOD AND DEVICE FOR VIDEO SURVEILLANCE

(71) Applicants: Ruben Heras Evangelio, Berlin (DE); Thomas Sikora, Berlin (DE); Ivo Keller, Potsdam (DE)

(72) Inventors: Ruben Heras Evangelio, Berlin (DE); Thomas Sikora, Berlin (DE); Ivo Keller, Potsdam (DE)

(73) Assignee: TECHNISCHE UNIVERSITAT BERLIN, Berlin (DE)

(21) Appl. No.: 13/194,771

(22) Filed: Jul. 29, 2011

(51) Int. Cl. H04N 7/18

(52) U.S. Cl. 348/143; 348/E07.085

(57) ABSTRACT

The invention relates to a method and a device for video surveillance, wherein, by means of at least one video camera, an image of an image excerpt of an environment to be monitored in the vicinity of the video camera is recorded, wherein at least one pixel of the image is compared with a corresponding pixel of a short-term background model assigned to the image excerpt and with a corresponding pixel of a long-term background model assigned to the image excerpt.

### BACKGROUND AND SUMMARY

The invention relates to a method and a device for video surveillance, wherein, by means of a video camera, an image of an environment to be monitored in the vicinity of the video camera is recorded.

EP 1 077 397 A1 discloses a method and a device for the video surveillance of process installations. In that case, a stored first reference image is compared with a first comparison image recorded by a video camera, and an alarm signal is output if the number of differing pixel values is greater than a predetermined threshold value. Furthermore, a second threshold value is provided, which is less than the first threshold value. If the number of differing pixel values lies between these two threshold values, then the associated comparison image is stored as a further reference image and used for subsequent comparisons with newly recorded comparison images.

WO 98/40855 A1 discloses a device for the video surveillance of an area with a video camera, which optically captures the area from a specific viewing angle, and an evaluation device, wherein video means for optically capturing the same area from a different viewing angle are provided and the evaluation device is suitable for processing the stereoscopic video information originating from the two viewing directions to form three-dimensional video image signal sets and for comparing the latter with corresponding reference signal sets of a three-dimensional reference model.

U.S. Pat. No. 5,684,898 discloses a method and a device for generating a background image from a plurality of images of a scene and for subtracting a background image from an input image. In order to generate a background image, an image is divided into partial images in order to obtain reference partial images for each position of a partial image, wherein successive partial images are compared with the reference partial image in order to recognize objects between the reference partial image and a video camera that has recorded the image.

Some known methods for detecting static objects in video sequences are based on the combination of background subtraction methods with tracking information, so-called tracking (cf. Bayona, Alvaro, San Miguel, Juan Carlos and Martinez Sánchez, Jose Maria. Comparative Evaluation of Stationary Foreground Object Detection Algorithms Based on Background Subtraction Techniques. Proceedings of the IEEE International Conference on Advanced Video and Signal Based Surveillance. 2009, pages 25-30; Guler, S., Silverstein, J. A. and Pushee, L H. Stationary objects in multiple object tracking. Proceedings of the IEEE. International Conference on Advanced Video and Signal Based Surveillance. 2007, 5.248-253; 3. Singh, A., et al. An Abandoned Object Detection System Based on Dual Background Segmentation. Proceedings of the IEEE International Conference on Advanced Video and Signal Based Surveillance. 2009, pages 352-357 and Venetianer, P. L., et al. Stationary target detection using the object video surveillance system. Proceedings of the IEEE International Conference on Advanced Video and Signal Based Surveillance, 2007, pages 242-247). What is disadvantageous about systems of this type is that tracking is a problem that is difficult to solve, particularly in scenarios with many moving objects, e.g. airports or stations.

As an alternative to the use of tracking information, use is made of dual background subtraction methods (cf. Porikli, Fatih, Ivanov, Yuri and Haga, Tetsuji: Robust abandoned object detection using dual foregrounds; EURASIP J. Adv. Signal Process. 2008) and methods which interpret the results of a background basic subtraction (cf. Tian, Y., Feris, R. S. and Hampapur, A.: Real-Time Detection of Abandoned and Removed Objects in Complex Environments; Proceedings of the IEEE International Workshop on Visual Surveillance; 2008).

What is disadvantageous about systems of this type is that static objects can also be recorded in the background, which leads to the recognition of “ghost objects” if these objects are removed. In order to solve this problem, the use of finite state machines (FSM) is proposed in Heras Evangelio, Ruben, Senst, Tobias and Sikora, Thomas: Detection of Static Objects for the Task of Video Surveillance; IEEE Workshop on Applications of Computer Vision (WACV); 2011 and in Heras Evangelio, Ruben, Pätzold, Michael and Sikora, Thomas: A system for Automatic and Interactive Detection of Static Objects; Proceedings of the IEEE Workshop on Person-Oriented Vision (POV) 2011.

What is disadvantageous about these systems is that they require knowledge of the empty scenery in advance. In Reddy, V., Sanderson, C. and Lovell, B. C.: A Low-Complexity Algorithm for Static Background Estimation from Cluttered Image Sequences in Surveillance Contexts; EURASIP Journal on Image and Video Processing; 2011 and Gutchess, D., et al.: A background model initialization algorithm for video surveillance; IEEE ICCV; 2001 attempts are made to provide a model of the empty scenery. In that case, however, the empty scenery has to be visible at least for a short moment during an initialization phase. This can be difficult particularly in certain situations, such as in public places and in buildings, since the background may not be visible for a long time in these cases.

It is an object of the invention to improve video surveillance, or make it more robust, particularly with regard to the recognition of static objects. In this case, it is desirable, in particular, for the video surveillance to require no initialization with empty scenery. It is an object of the invention, in particular, to provide video surveillance for recognizing static objects with a high degree of recognition certainty in conjunction with a lower false alarm rate. It is desirable, in particular, to provide video surveillance for recognizing static objects which is suitable particularly for situations with a high proportion of non-static objects. It is desirable, in particular, to provide video surveillance for recognizing static objects which is particularly suitable for airports and stations.

The object mentioned above is achieved by means of a method for video surveillance, wherein, by means of at least one video camera, an image of an image excerpt of an environment to be monitored in the vicinity of the video camera is recorded, wherein at least one pixel of the image is compared with a corresponding pixel of a short-term background model assigned to the image excerpt and with a corresponding pixel of a long-term background model assigned to the image excerpt, and wherein it is provided, in particular, that a pixel of the image which differs from the corresponding pixel of the short-term background model and from the corresponding pixel of the long-term background model is classified as a foreground pixel, wherein a plurality of (adjacent) foreground pixels are advantageously assigned to a region.

An image excerpt within the meaning of the invention is, in particular, the area which is captured by the video camera. An image excerpt within the meaning of the invention is, in particular, that part of the surroundings of the video camera which is imaged by means of the image.

A pixel within the meaning of the invention is, in particular, one pixel. However, a pixel within the meaning of the invention can also comprise or be a group of pixels. Such a group of pixels can be, for example, an area of a picture unit.

A background model can be, for example, a background model in accordance with U.S. Pat. No. 5,684,898. Background models can be generated for example in accordance with the methods described in the article by Stauffer, Chris and Crimson, W. E. L.: Adaptive background mixture models for real-time tracking; Proceedings of the IEEE Conference on Computer Vision and Pattern Recognition; 1999 wherein any model that can model a multimodal density distribution (cf., for example, Zivkovic: Improved adaptive Gaussian mixture model for background subtraction; Proceedings of the International Conference on Pattern Recognition; 2004) can be used. A background model within the meaning of the invention is, in particular, a model of the statistical components of the image which is recorded by the video camera. A short-term background model within the meaning of the invention includes, in particular, pixel values which have a relative statistical relevance with respect to other values observed in the same pixel during a first time interval (values in this sense are colors, in particular). A long-term background model within the meaning of the invention includes, in particular, pixels which have a relative statistical relevance with respect to other values observed in the same pixel during a second time interval. A second time interval within the meaning of the invention contains the first time interval and/or is, in particular depending on the temporal resolution of the video sequence and on the desired sensitivity of the system, longer than a first time interval within the meaning of the invention. A short-term background model within the meaning of the invention is calculated, in particular, from the statistical evaluation of a video sequence of a first time window. A long-term background model within the meaning of the invention is calculated, in particular, from the statistical evaluation of a video sequence (=temporal succession of successive images) of a second time window. A second time window within the meaning of the invention is, in particular depending on the temporal resolution of the video sequence and on the desired sensitivity of the system, larger than a first time window within the meaning of the invention.

It can be provided, in particular, that a predetermined number of modes (colors) is or has been assigned to a pixel of a background model. Thus, by way of example, five different colors and the frequency thereof can be assigned to a pixel of a background model. Within the meaning of the invention, a pixel of an image differs from a corresponding pixel of a background model in particular when the color of the pixel of the image corresponds to none of the predetermined number of colors (modes) of the background model.

Two pixels are designated as corresponding within the meaning of the invention in particular when they have the same coordinates or lie at the same location. A comparison of background models within the meaning of the invention optionally also encompasses a comparison of variables derived from or dependent on the background models, such as e.g. of foreground masks.

A region within the meaning of the invention is, in particular, a static region. A region within the meaning of the invention comprises, in particular, adjacent/contiguous pixels having identical features or properties. In this case, a region within the meaning of the invention is regarded as finished in particular when its growth has ended. That is to say, in particular, that a plurality of temporally offset images/frames are employed/used for assessing/defining/determining a region.

In a furthermore advantageous configuration of the invention, depending on an area—corresponding to the region—of a subsequent image of the image excerpt, a removed object is recognized or it is determined whether the removal of an object has been recognized. In this case, it is provided, in particular, that the removal of a (static) object is regarded as recognized or a removed (static) object is recognized or it is determined whether the removal of an object has been recognized if the pixels of the image within that area of the subsequent image which corresponds to the region can be or are assigned to a single region. An area corresponding to a region within the meaning of the invention is, for example, the contour of the region or a so-called bounding box assigned to the region. In this case, a bounding box is the smallest rectangle that covers the region.

It may be provided that “subsequent” within the meaning of the invention means “later” and not “directly following”.

In a furthermore advantageous configuration of the invention, depending on an area—corresponding to the region—of the long-term background model, a removed object is recognized or it is determined whether the removal of an object has been recognized. In this case, it is provided, in particular, that the removal of an object is recognized or determined or regarded as recognized if the corresponding region of the long-term background model correspond to the foreground pixels of the region. Correspondence in this sense can mean that they have or define or establish identical features, such as e.g. identical edges.

In a furthermore advantageous configuration of the invention, upon recognition of the removal of an object, that area of the long-term background model which corresponds to the region is replaced by that area of the short-term background model which corresponds to the region.

In a furthermore advantageous configuration of the invention, depending on the/an area—corresponding to the region—of the/a subsequent image of the image excerpt, an added object is recognized or it is determined whether the addition of an object has been recognized, wherein it is provided, in particular, that the addition of a (static) object is recognized or defined as recognized if the pixels of the area—corresponding to the region—of the/a subsequent image of the image excerpt correspond to the foreground pixels of the region. Correspondence in this sense can mean that the regions have or define or establish identical features, such as e.g. identical edges. It is provided, in particular, that, upon the determination “addition of a (static) object”, an alarm, a message or a hazard warning message is generated or output. This can be done optically and/or acoustically, for example.

In a furthermore advantageous configuration of the invention, if a pixel differs from the corresponding pixel of the short-term background model, but not from the corresponding pixel of the long-term background model, the corresponding pixel of the short-term background model is replaced by the corresponding pixel of the long-term background model. In a furthermore advantageous configuration of the invention, if a pixel differs from the corresponding pixel of the short-term background model, but not from the corresponding pixel of the long-term background model, the short-term background model is replaced by the long-term background model.

In a furthermore advantageous configuration of the invention, if a pixel differs from the corresponding pixel of the long-term background model, but not from the corresponding pixel of the short-term background model, the corresponding pixel of the long-term background model is replaced by the corresponding pixel of the short-term background model, but in a manner reduced by the color of the pixel. In a furthermore advantageous configuration of the invention, this is provided only a single time, however, for a pixel. In a furthermore advantageous configuration of the invention, if a pixel differs from the corresponding pixel of the long-term background model, but not from the corresponding pixel of the short-term background model, the long-term background model is replaced by the short-term background model, but in a manner reduced by the color of the pixel. In a furthermore advantageous configuration of the invention, this is provided only a single time, however, for a pixel.

The abovementioned object is achieved—in particular in conjunction with features mentioned above—in addition by means of a device for video surveillance, in particular for carrying out a method mentioned above, wherein the device for video surveillance comprises at least one video camera for recording an image of an image excerpt of an environment to be monitored in the vicinity of the video camera, a short-term background model assigned to the image excerpt, a long-term background model assigned to the image excerpt, and also an evaluation device for comparing at least one pixel of the image with a corresponding pixel of the short-term background model and with a corresponding pixel of the long-term background model.

Further advantages and details will become apparent from the following description of exemplary embodiments. In this case, in the figures:

### BRIEF DESCRIPTION OF THE DRAWINGS

FIG. 1 shows an exemplary embodiment of a device for video surveillance;

FIG. 2 shows an exemplary embodiment of an evaluation device with evaluation modules;

FIG. 3 shows an exemplary embodiment of a finite state machine;

FIG. 4 shows an exemplary embodiment of a method implemented in a (low-level) evaluation module in accordance with FIG. 2;

FIG. 5 shows an exemplary embodiment of a method implemented in a (high-level) evaluation module in accordance with FIG. 2;

FIG. 6 shows an exemplary embodiment of a current image (frame, input frame);

FIG. 7 shows an exemplary embodiment of a region formed from preceding images corresponding to the image section in accordance with FIG. 6, or a corresponding mask;

FIG. 8 shows an exemplary embodiment of a corresponding long-term background model in the area corresponding to the (analyzed) region in accordance with FIG. 7;

FIG. 9 shows an exemplary embodiment of recognized edges in the current image (frame, input frame) in accordance with FIG. 6;

FIG. 10 shows an exemplary embodiment of recognized edges of the region or mask in accordance with FIG. 7;

FIG. 11 shows an exemplary embodiment of recognized edges in the corresponding area in accordance with FIG. 8;

FIG. 12 shows an exemplary embodiment of a current image (frame, input frame);

FIG. 13 shows an exemplary embodiment of a formed from preceding images corresponding to the image section in accordance with FIG. 12;

FIG. 14 shows an exemplary embodiment of a corresponding long-term background model in the area corresponding to the (analyzed) region in accordance with FIG. 13;

FIG. 15 shows an exemplary embodiment of recognized edges in the current image (frame, input frame) in accordance with FIG. 12;

FIG. 16 shows an exemplary embodiment of recognized edges of the region in accordance with FIG. 13; and

FIG. 17 shows an exemplary embodiment of recognized edges in the corresponding area in accordance with FIG. 14.

### DETAILED DESCRIPTION

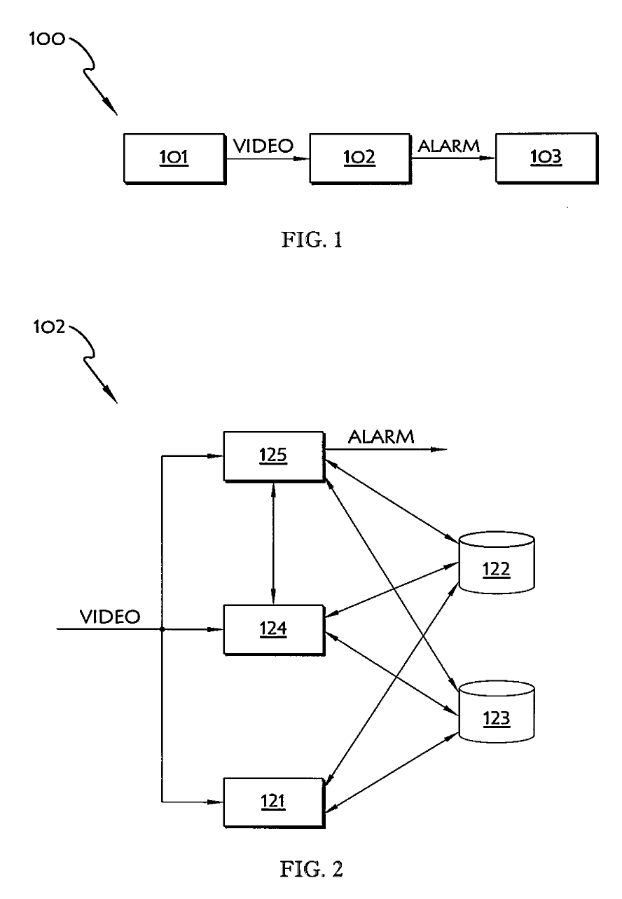

FIG. 1 shows an exemplary embodiment of a device 100 for video surveillance, comprising a video camera 101 for recording an image VIDEO of an image excerpt in an environment to be monitored in the vicinity of the video camera 101. The image VIDEO is analyzed by means of an evaluation device 102 in order to recognize static objects such as, for example, bags or suitcases left at an airport or station. If the evaluation device 102 recognizes a static object in the image VIDEO, then it outputs a corresponding message ALARM to an output device 103.

The evaluation device 102 comprises—as illustrated in FIG. 2—a model updating module 121 for updating or generating a short-term background model 122 and a long-term background model 123. The short-term background model 122 and the long-term background model 123 are updated in different time intervals (complementary background modeling). A (low-level) evaluation model 124 and a (high-level) evaluation module 125 are additionally provided.

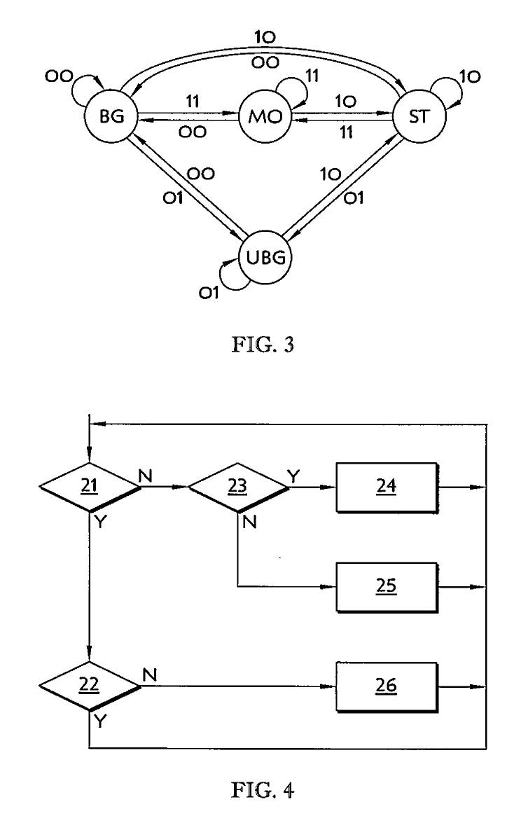

FIG. 3 describes the functioning of the (low-level) evaluation module 124 by means of a finite state machine (FSM). Said state machine is distinguished by the fact that it permits only four states:

BG: a pixel belongs to the background.

MO: a pixel belongs to a moving object.

ST: a pixel belongs to an added (static) object.

UBG: a pixel belongs to a removed object, that is to say a now visible background (uncovered background).

The finite state machine (FSM) is defined as a 5-tuple (I, Q, δ, ω),

where I is the possible combinations of the results of a background subtraction,

where Q denotes the set of states (BG (background), MO (moving), ST (new static) and UBG (uncovered background)) which a pixel (or picture unit) can run through,

where Z is the set of numbers which is the classification of the pixels (or picture units) (Z≡{0,1, . . . |Q |]),

where δ is the next/following state in accordance with FIG. 3,

and where ω is the output function with output values Zε{0,1, . . . |Q|}in accordance with the state of a pixel (or picture unit).

FIG. 4 shows a method implemented in the evaluation module 124. In this case, reference symbol 21 designates the interrogation as to whether the pixel of an image (frame) is identical to the corresponding pixel of the short-term background model 122. Reference symbols 22 and 23 respectively designate the interrogation as to whether the pixel of an image (frame) is identical to the corresponding pixel of the long-term background model 123. If the interrogations 21 and 23 reveal that the pixel differs from the corresponding pixel of the short-term background model, but not from the corresponding pixel of the long-term background model 123, then the interrogation 23 is followed by a step 24, in which the corresponding pixel of the short-term background model 122 is replaced by the corresponding pixel of the long-term background model 123.

If the interrogations 21 and 22 reveal that the pixel differs from corresponding pixels of the long-term background model 123, but not from the corresponding pixel of the short-term background model 122, then the interrogation 22 is followed by a step 26, in which the corresponding pixel of the long-term background model 123 is replaced by the corresponding pixel of the short-term background model 122, but in a manner reduced by the color of the pixel of the image. If a color/mode is removed, its weight ωⱼ (statistical frequency) is distributed among the other colors or modes, that is to say that:

ωₖ=ωₖ+ωⱼ/(B−1), ∀k=1. . . B,k≠j,

where j≦B denotes the removed color or the removed mode and B>1 denotes the number of colors or modes. B can be 5, for example. Step 26 is provided only a “first time” or once in particular for the corresponding pixel/partial image (that is to say in the first transition from MO to ST from FIG. 3). In this case, the pixel is marked as a static foreground until it jumps further either to BG or UBG.

If the interrogations 21 and 23 reveal that the pixel differs from the corresponding pixel of the long-term background model 123 and from the corresponding pixel of the short-term background model 122, then said pixel is classified as foreground or as foreground pixel (step 25). A corresponding notification is effected to the evaluation module 125, in which the method described below with reference to FIG. 5 is implemented.

The method implemented in the evaluation module 125 begins with a step 31, in which a region is formed from adjacent/contiguous static foreground pixels (which were marked in step 26). (Optionally, only the pixels marked as static foreground pixels over a given time are taken.) Step 31 is followed by an interrogation 32, which involves interrogating whether the determined region grows with respect to a corresponding region at the previous point in time or one or more of the previous points in time. If the growth has ended, the region (also called mask hereinafter) is therefore finished, and so the interrogation 32 is followed by an analysis of the region in a step 33. In this case, the position and size of a bounding box at the point in time of its occurrence and also its disappearance are stored for each new static region.

An interrogation 34 ensues, which involves interrogating whether a moving object is moving through the region. If no moving object is moving through the region, then the interrogation 34 is followed by an interrogation 35. The interrogation 35 involves interrogating whether the features of a current image in the area corresponding to the bounding box are part of a single region. If this is the case, then the interrogation 35 is followed by a step 36, in which it is assumed that the region belongs to a removed object, such that now the background (empty scenery) is visible with respect to the region. In addition, that area of the long-term background model 123 which corresponds to the region is replaced by that area of the short-term background model 122 which corresponds to the region.

If the features of a current image in the area corresponding to the bounding box are not part of a single region, then the interrogation 35 is followed by an interrogation 37, which involves interrogating whether (the) features in that area of the long-term background model 123 which corresponds to the region correspond to the corresponding features of the region or mask. If (the) features in that area of the long-term background model 123 which corresponds to the region correspond to the corresponding features of the region or mask, then the interrogation 37 is followed by the step 36.

If (the) features in that area of the long-term background model 123 which corresponds to the region do not correspond to the corresponding features of the region or mask, then the interrogation 37 is followed by an interrogation 38, which involves interrogating whether (the) features in that area of the (current) image/frame which corresponds to the region correspond to the corresponding features of the region or mask. If (the) features in that area of the (current) image/frame which corresponds to the region correspond to the corresponding features of the region or mask, then the interrogation 38 is followed by a step 39, in which the new static region is assigned to an added static object. In addition, the message ALARM is output.

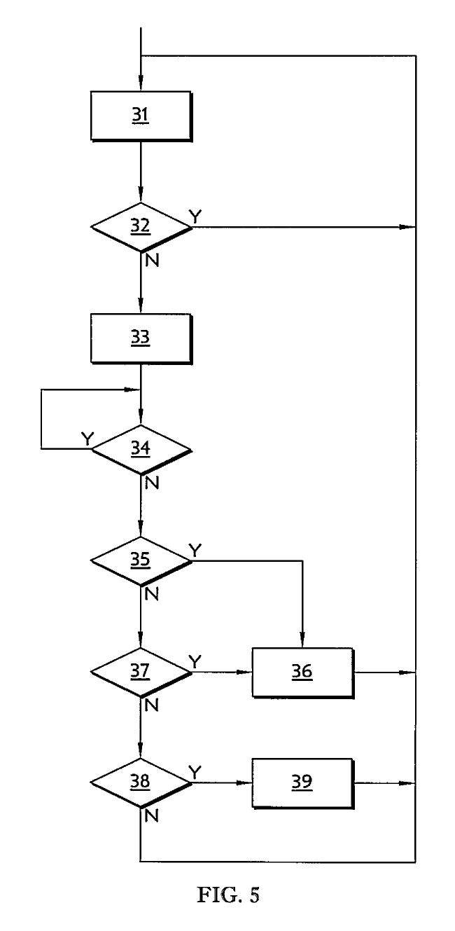

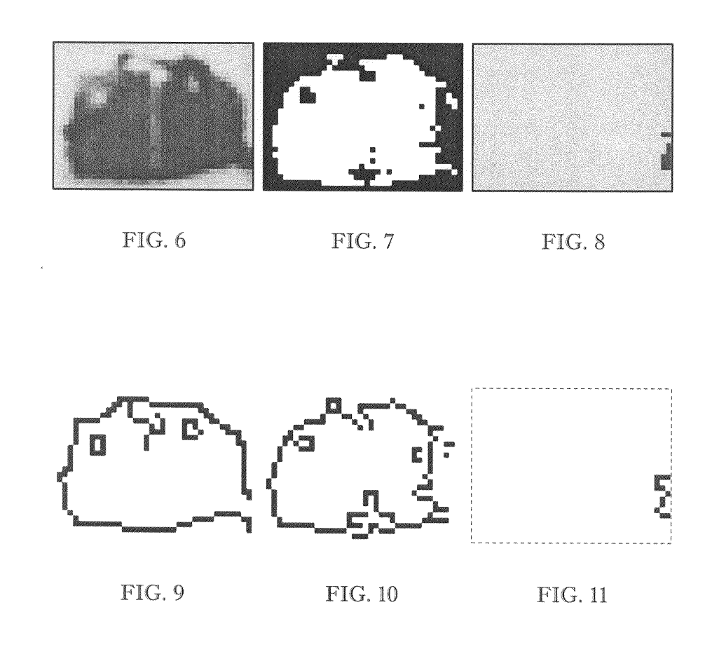

The functioning of the evaluation device 102 is explained below on the basis of the examples illustrated in FIG. 6 to FIG. 17. In this case, FIG. 6 shows a current image (frame, input frame) and FIG. 7 shows a region formed from preceding images corresponding to the image section in accordance with FIG. 6, or a corresponding mask. FIG. 8 shows the corresponding long-term background model 123 in the analyzed region. FIGS. 9, 10 and 11 show the edges corresponding to FIGS. 6, 7 and 8. In this case, the frame illustrated in a dotted fashion in FIG. 5 is not part of the long-term background model. The edges of the image (see FIG. 9) correspond to the edges of the region (see FIG. 10), such that that part of the image which corresponds to the region (see FIG. 6) is classified as a new static object.

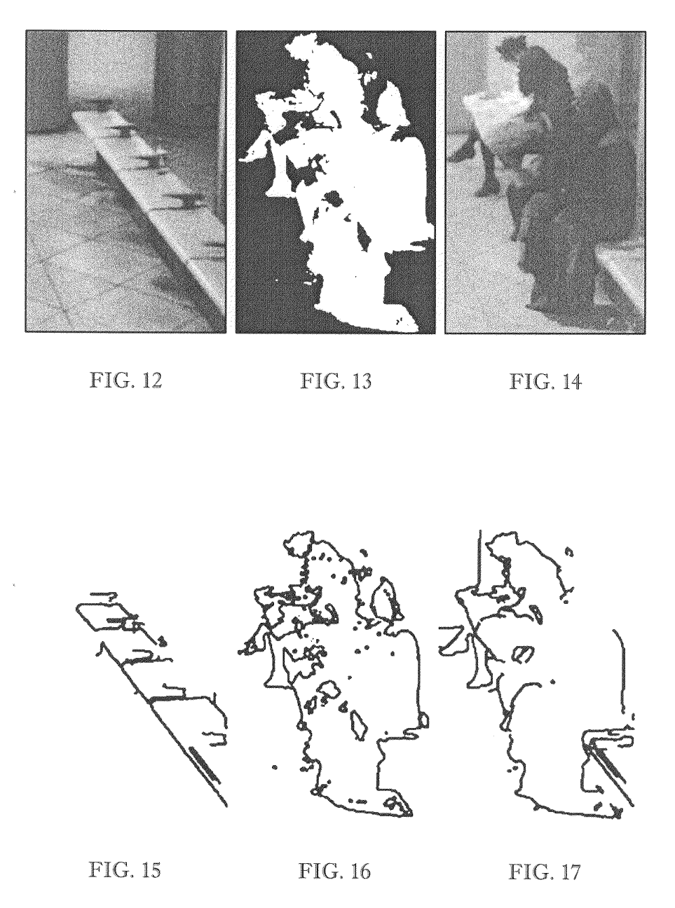

FIGS. 12 to 17 describe a further example, wherein FIG. 12 shows a current image (frame, input frame) and FIG. 13 shows a region formed from preceding images corresponding to the image section in accordance with FIG. 12, or a corresponding mask. FIG. 14 shows the corresponding long-term background model 123 in the analyzed region. FIGS. 15, 16 and 17 show the edges corresponding to FIGS. 12, 13 and 14. The edges of the long-term background model 123 in the analyzed region (see FIG. 17) correspond to the edges of the region (see FIG. 16), such that that part of the image which corresponds to the region (see FIG. 12) is classified as a removed static object.

1. Method for video surveillance, wherein, by means of at least one video camera, an image of an image excerpt of an environment to be monitored in the vicinity of the video camera is recorded, wherein at least one pixel of the image is compared with a corresponding pixel of a short-term background model assigned to the image excerpt and with a corresponding pixel of a long-term background model assigned to the image excerpt.

2. Method according to claim 1, wherein a pixel of the image which differs from the corresponding pixel of the short-term background model and from the corresponding pixel of the long-term background model is classified as a foreground pixel.

3. Method according to claim 2, wherein a plurality of (adjacent) foreground pixels are assigned to a region.

4. Method according to claim 3, wherein, depending on an area—corresponding to the region—of a subsequent image of the image excerpt, it is determined whether the removal of an object has been recognized.

5. Method according to claim 3, wherein, depending on an area—corresponding to the region—of the long-term background model, it is determined whether the removal of an object has been recognized.

6. Method according to claim 4, wherein, upon recognition of the removal of an object, that area of the long-term background model which corresponds to the region is replaced by that area of the short-term background model which corresponds to the region.

7. Method according to claim 3, wherein, depending on the area—corresponding to the region—of a subsequent image of the image excerpt, it is determined whether the addition of an object has been recognized.

8. Method according to claim 1, wherein, if a pixel differs from the corresponding pixel of the short-term background model, but not from the corresponding pixel of the long-term background model, the corresponding pixel of the short-term background model is replaced by the corresponding pixel of the long-term background model.

9. Method according to claim 1, wherein, if a pixel differs from the corresponding pixel of the long-term background model, but not from the corresponding pixel of the short-term background model, the corresponding pixel of the long-term background model is replaced by the corresponding pixel of the short-term background model, but in a manner reduced by the color of the pixel.

10. Device for video surveillance, wherein the device for video surveillance comprises at least one video camera for recording an image of an image excerpt of an environment to be monitored in the vicinity of the video camera, a short-term background model assigned to the image excerpt, a long-term background model assigned to the image excerpt, and also an evaluation device for comparing at least one pixel of the image with a corresponding pixel of the short-term background model and with a corresponding pixel of the long-term background model.
